(19) United States
(12) Patent Application Publication
(10) Pub. No.: US 2004/0187146 A1
(43) Pub. Date: Sep. 23, 2004

(54) Entertainment terminal and entertainment service apparatus using the same

(75) Inventor: Norihisa Iga, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/795,281

(22) Filed: Mar. 9, 2004

(30) Foreign Application Priority Data
Mar. 19, 2003 (JP) 2003-076231

(51) Int. Cl. H04N 7/173; H04N 5/445; G06F 3/00; G06F 13/00; H04N 7/16

(52) U.S. Cl. 725/28; 725/25; 725/87; 725/61

(57) ABSTRACT

In a method of providing contents data in an entertainment service system, a request of desired contents data is generated from an entertainment terminal. It is determined whether a customer has a right to display contents data, in response to the desired contents data request. The desired contents data is retrieved from a contents database based on the determination result, when the customer has the right. The desired contents data is displayed the on the entertainment terminal.

### BACKGROUND OF THE INVENTION

1. Field of the Invention

The present invention relates to an entertainment terminal and an entertainment service apparatus using the same, and more particularly to an entertainment terminal and an entertainment service apparatus using the same, in which contents data is view and used.

2. Description of the Related Art

An entertainment service system is conventionally known, in which a conventional entertainment terminal is arranged at a table in a restaurant and contents data is displayed on the entertainment terminal while a customer waits a service of ordered meal. At this time, the customer can view and use the contents data by operating the entertainment terminal, selecting the contents data and paying money. An entertainment service apparatus is desired which can prevent the customer from viewing and using the contents data without limitation.

A restaurant service system is described in Japanese Laid Open Patent Application (JP-P2000-123088A). In this conventional example, a menu is displayed on the screen of a display and an order is issued through a touch operation to the screen.

Also, an order supporting system is described in Japanese Laid Open Patent Application (JP-P2001-306666A). In this conventional example, detailed data of meals are displayed so that a customer can select a desired one of the meals.

Also, an ordering system is described Japanese Laid Open Patent Application (JP-P2002-140412A). In this conventional example, a customer can order a desired meal by operating a touch panel on which images of a plurality of meals are displayed or by inputting an identifier of the desired meal. Also, the customer can spend a waiting time for the ordered meal by viewing contents data free or in charge.

Also, a sales promotion system is described in Japanese Laid Open Patent Application (JP-P2002-183572A). In this conventional example, issuance of discount coupons is made to relate to sale promotion

Also, a desk-type data management apparatus is described in Japanese Laid Open Patent Application (JP-A-Heisei 08-263444). In this conventional example, the desk-type data management apparatus is provided on a table in a restaurant to allow a customer to input an order, and to acquire external data and use a game function.

### SUMMARY OF THE INVENTION

Therefore, an object of the present invention to provide an entertainment terminal and an entertainment service apparatus using the same, in which unlimited use by a customer can be prevented.

In an aspect of the present invention, a method of providing contents data in an entertainment service system, is achieved by generating a request of desired contents data from an entertainment terminal; by determining whether a customer has a right to display contents data, in response to the desired contents data request; by retrieving the desired contents data from a contents database based on the determination result, when the customer has the right; and by displaying the desired contents data on the entertainment terminal.

Here, the generating is achieved by generating the desired contents data request from the entertainment terminal together with identifier for identifying the entertainment terminal.

Also, the determining step may be achieved by calculating a summation of order point data determined based on an order and carried-forward point data; by comparing the summation and point data necessary for the desired contents data; by determining that the customer has the right when the summation is equal to or larger than the necessary point data; and by determining that the customer does not have the right when the summation is equal to or larger than the necessary point data. In this case, the method may further include generating the order directly from the entertainment terminal or through a mobile terminal of the customer.

Also, the method may further include settling an expense for the order; subtracting the necessary point data from the summation; and storing a remainder as the result of the subtraction as the carried-forward point data.

In another aspect of the present invention, an entertainment service apparatus includes an order receiving section which receives orders from an order terminal for every identification for identifying an entertainment terminal; and a determining section which determines whether a customer has a right to display desired contents data on the entertainment terminal, based on the order, and notifies the determination result to the entertainment terminal. The entertainment terminal may be available to display the desired contents data when the determination result indicates that the customer has the right.

In this case, the orders may contain an order of displaying the desired contents data on the entertainment terminal.

Also, the entertainment service apparatus may further include a settling section which calculates an expense based on the orders and notifies the expense to a cash register. In this case, the entertainment service apparatus may further include a history acquiring section which acquires used point data corresponding to the desired contents data having displayed on the entertainment terminal; and a storing section which stores as carried forward point data in a carried-forward point database, point data obtained by subtracting the used point data from a summation of the purchased point data, point data given for the order other than the order of displaying the desired contents data and carried-forward point data, at the calculation of the expense. The determination result indicates that the customer does not have the right when purchased point data calculated based on the order exceeds the used point data.

Also, entertainment service apparatus may further include a carried-forward point data acquiring section which acquires the carried forward point data corresponding to the user identifier from the carried-forward point database, when the customer requests the display of the desired contents data. The determination result indicates that the customer has the right when the used point data is smaller than the summation. In this case, the carried-forward point database may be arranged in a use condition storage server. The storing section may transmit the carried-forward point data and a user identifier of the customer in the use condition storage server, such that the carried-forward point data is stored in the carried-forward point database in relation to the user identifier. The carried-forward point data acquiring section may read out the carried-forward point data from the use condition storage server based on the user identifier acquired on the reception of the order of displaying the desired contents data. Also, the entertainment terminal may acquire the user identifier from a mobile terminal, and the user identifier is data for identifying the mobile terminal.

Also, the entertainment service apparatus may further include the storing section stores the carried forward point data in the mobile terminal through the entertainment terminal. The carried-forward point data acquiring section may acquire the carried-forward point data from the mobile terminal through the entertainment terminal.

Also, a tag may be provided near the entertainment terminal. The order terminal may include a reader which reads the number from the tag. In this case, a barcode may be written on the tag, and the reader may read the number from the barcode. Also, the tag may be an IC tag which outputs a response radio wave to show the number in response to irradiation of predetermined radio wave, and the reader may be an IC tag reader which outputs the predetermined radio wave to the IC tag and reads the table number from the response radio wave.

In another aspect of the present invention, an entertainment terminal includes an order notifying section which notifies orders to an entertainment service apparatus; a determination result acquiring section which acquires from the entertainment service apparatus, a determination result of whether or not a customer has a right to display desired contents data based on the orders; and a contents data display section which displays the desired contents data when the determination result indicates that the customer has the right.

Here, the entertainment terminal may further include a history notifying section which notifies used point data corresponding to the desired contents data displayed on the entertainment terminal, to the entertainment service apparatus. The determination result indicates that the user does not have the right when the used point data exceeds calculation point data calculated based on the orders.

Also, the entertainment terminal may further include a carried-forward point data requesting section which notifies a user identifier inputted through an operation of the entertainment terminal by the customer to the entertainment service apparatus. The entertainment service apparatus may retrieve carried-forward point data corresponding to the user identifier from a carried-forward point database. The determination result indicates that the user has the right when the used point data is smaller than a summation of the calculation point data and the carried-forward point data.

In this case, the carried-forward point data requesting section may acquire the user identifier from a mobile terminal. Also, the user identifier may be data for identifying the mobile terminal.

Also, the entertainment terminal may further include a contents database which stores contents data. The contents data display section may refer to the contents database to display the desired contents data.

In another aspect of the present invention, a software product is executable by a computer and achieves the functions of:

receiving orders from an order terminal for every identification for identifying an entertainment terminal;

determining whether a customer has a right to display desired contents data on the entertainment terminal, based on the order; and

notifying the determination result to the entertainment terminal.

Also, in another aspect of the present invention, a software product is executable by a computer and achieves the functions of:

notifying orders to an entertainment service apparatus;

acquiring from the entertainment service apparatus, a determination result of whether or not a customer has a right to display desired contents data based on the orders; and

displaying the desired contents data when the determination result indicates that the customer has the right.

### BRIEF DESCRIPTION OF THE DRAWINGS

FIG. 1 is a block diagram showing the configuration of an entertainment service system according to an embodiment of the present invention;

FIG. 2 is a block diagram showing the configuration of an entertainment service apparatus used in the entertainment service system according to the embodiment of the present invention;

FIG. 3 is a block diagram showing an order database;

FIG. 4 is a block diagram showing a carried-forward point database;

FIG. 5 is a block diagram showing the configuration of an entertainment terminal;

FIG. 6 is a block diagram showing the configuration of a mobile terminal;

FIG. 7 is a flow chart showing an operation of the entertainment service system according to the embodiment of the present invention;

FIG. 8 is a flow chart showing another operation of the entertainment service system according to the embodiment of the present invention; and

FIG. 9 is a flow chart showing still another operation of the entertainment service system according to the embodiment of the present invention.

### DESCRIPTION OF THE PREFERRED EMBODIMENTS

Hereinafter, an entertainment service system using an entertainment service apparatus of the present invention will be described with reference to the attached drawings.

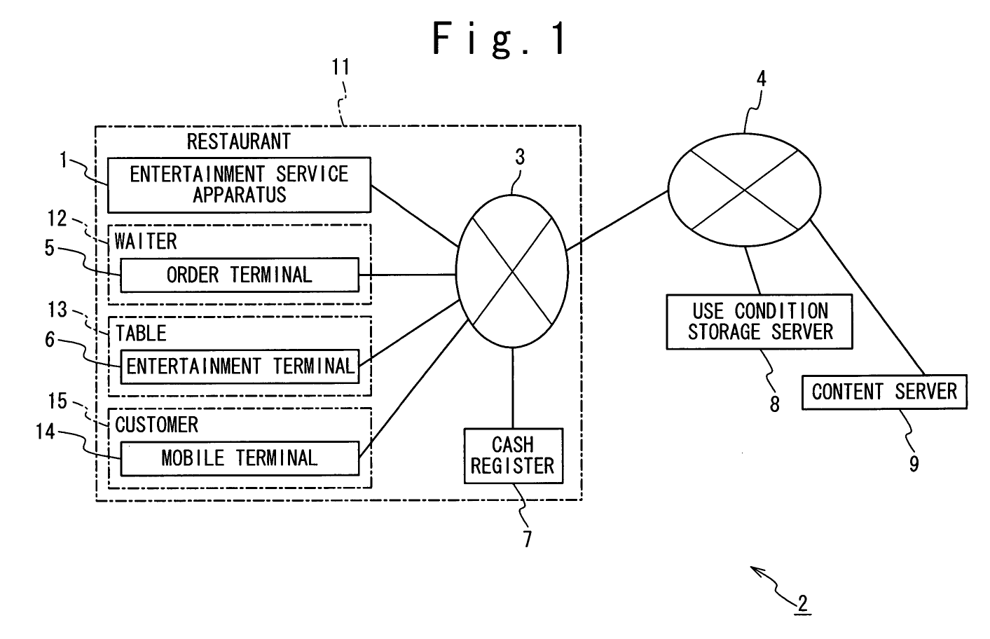

FIG. 1 is a block diagram showing the configuration of the entertainment service system 2 according to an embodiment of the present invention. The entertainment service apparatus 1 is provided for each of a plurality of restaurants 11, and the entertainment service system 2 is composed of a use condition storage server 8, a contents server 9 and the entertainment service apparatus 1 for every restaurant 11, which are connected with the Internet 4. The use condition storage server 8 and the contents server 9 are realized based on computer programs. Each of the plurality of restaurants accommodates a plurality of tables 13, and provides various types of meals to a customer. A table number is allocated to each table 13 to identify each table 13. Thus, the table and an entertainment terminal 6 can be identified. Also, the customer can be identified when the customer is single or a representative can be identified when a group of customers sit at the table. For the purpose of identification of the table, a seal on which a barcode is written is stuck on the table 13 or an IC tag outputs radio wave to show the table number in response fixed radio wave. In the restaurant 11, the entertainment service apparatus 1, an order terminal 5, an entertainment terminal 6, and a cash register 7 are provided to be connected with a LAN 3. The LAN 3 is connected with the Internet 4. The entertainment service apparatus 1, the order terminal 5, the entertainment terminal 6, and the cash register 7 are realized based on computer programs, respectively. The entertainment terminal 6 is provided for each table 13. Therefore, if the table 13 is identified, the entertainment terminal 6 can be identified. If a plurality of entertainment terminals 6 are provided for the table 13, each entertainment terminal 6 may be identified by using an entertainment terminal identifier in place of the table number or identifier.

The entertainment service apparatus 1 is an information processing terminal which is exemplified by a work station and is arranged in the restaurant 11. The order terminal 5 is carried and used by a waiter 12. The order terminal 5 is composed of a barcode reader (not shown) or an IC tag reader (not shown). The barcode reader reads data written in the barcode. The IC tag reader radiates predetermined radio wave to the IC tag, and reads data shown in radio wave from the IC tag in response to irradiation of the radio wave.

The entertainment terminal 6 is provided for each table 13 and is operated by customers of the tables 13. The entertainment terminal 6 is composed of a display unit and an input device (both not shown). Moreover, the entertainment terminal 6 can communicate with the order terminal 5 bi-directionally using infrared rays. The cash register 7 is arranged in the restaurant 11, and is used by a casher for the settlement of expense for the meal. The cash register 7 may be constituted as the same information processing terminal as the entertainment service apparatus 1.

The use condition storage server 8 is an information processing terminal which is exemplified by a work station and is composed of a point database. The use condition storage server 8 stores data transmitted from the entertainment service apparatus 1 in the point database and transmits requested point data to the entertainment service apparatus 1. The contents server 9 is an information processing terminal which is exemplified by a work station and provides contents data to the information processing terminal which is connected with the Internet 2. It should be noted that the contents server 9 may be formed as the same information processing terminal as the entertainment service apparatus 1.

The entertainment service system 2 is further composed of a mobile terminal 14. A portable phone exemplifies the mobile terminal 14. The mobile terminal 14 can communicate with the entertainment terminal 6 and the cash register 7 bi-directionally by infrared rays. A customer 15 of the restaurant 11 carries with the mobile terminal 14.

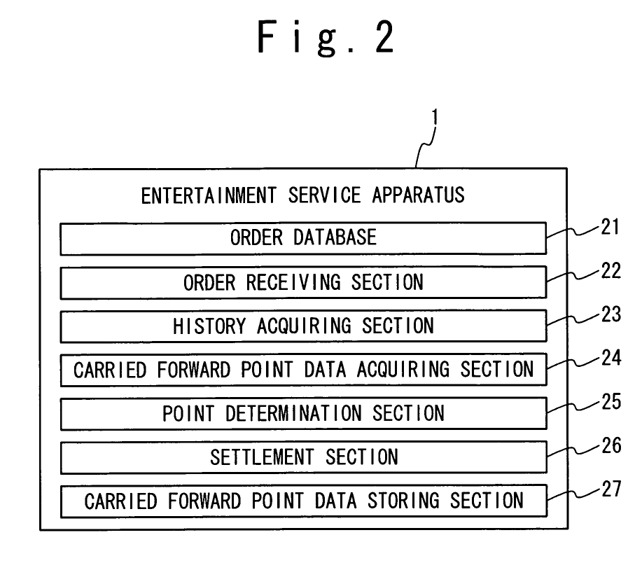

FIG. 2 shows the entertainment service apparatus 1 in detail. The entertainment service apparatus 1 is composed of an order database 21, an order receiving section 22, a history acquiring section 23, a carried-forward point data acquiring section 24, an point determination section 25, a settlement section 26 and a carried-forward point data storing section 27, which are achieved by computer programs.

The order database 21 stores data of the customer 15 sitting at the table 13. The order receiving section 22 receives an order from the customer 15 through the order terminal 5 or the entertainment terminal 6 through the LAN 3, and stores data of the order in the order database 21. The history acquiring section 23 acquires used point data corresponding to contents data to have been displayed on the entertainment terminal 6 through the LAN 3. The used point data may be the number of displayed contents data, a time of the display or a fee to the display. The carried-forward point data acquiring section 24 transmits a user identifier acquired from the entertainment terminal 6 to the use condition storage server 8 through the Internet 4. Also, the carried-forward point data acquiring section 24 acquires the carried-forward point data from the use condition storage server 8 and stores the carried-forward point data to the order database 21.

When a contents data display request is issued from the entertainment terminal 6, the point determination section 25 refers to the order database 21 and determines whether the entertainment terminal 6 has a right to display the contents data. The determination result is transmitted from the point determination section 25 to the entertainment terminal 6. For example, when the entertainment terminal 6 in the table 13 or the order terminal does not receive any order, the customer can view or use the contents data for 10 minutes. When the entertainment terminal 6 in the table 13 or the order terminal receives an order, the customer can view the contents data for 20 minutes or more.

Moreover, the point determination section 25 can determine whether the entertainment terminal 6 has the right to view or use the contents data, based on the requested contents data and the table number. At this time, the use of the contents data may be restrained based on the position of the entertainment terminal 6 arranged in the restaurant 11. For example, the entertainment terminal 6 at near a lavatory or the window, and at no smoking seat or at smoking seat, can use predetermined contents data, respectively.

Furthermore, the point determination section 25 can determine whether the entertainment terminal 6 has the right to view or use the contents data based on a time of the order. At this time, the use of the contents data can be restrained based on the situation of the restaurant 11. For example, the entertainment terminal 6 can use predetermined different contents data in the time zone when the restaurant 11 congests or the other time zone.

Also, the point determination section 25 refers to the order database and calculates usable point data for the contents data to be displayed on the entertainment terminal 6 for every customer 15. The determination result is displayed on the entertainment terminal 6 as usable point data. The calculated usable point data may indicate the available number of contents data, a time and a fee for the customer to view, and is increased in accordance with an additional order from the customer 15. The usable point data is a summation of point data corresponding to the orders and carried forward point data. It should be noted that the point determination section 25 may give the right to display specific contents data to the entertainment terminal 6 of the table 13 when a specific item of menu is ordered.

The settlement section 26 acquires the table number of the table 13 in which the customer 15 has sat, from the cash register 7 after the customer 15 finishes the meal, and refers to the order database 21 to calculate the expense for the orders and to transmit the calculated expense to the cash register 7.

In case that the entertainment terminal 6 has the usable point data more than the used point data for the contents data when the customer 15 settles the expense, the carried-forward point data storing section 27 transmits the carried-forward point data to the use condition storage server 8, and stores the carried-forward point data in the carried forward point database. Also, the carried forward point data storing section 27 acquires the user identifier corresponding to the carried-forward point data from the use condition storage server 8 and transmits to the cash register 7. Also, in case that the entertainment terminal 6 has the usable point data more than the used point data for the contents data when the customer 15 settles the expense, the carried-forward point data storing section 27 acquires the user identifier from the cash register 7, transmits the acquired user identifier together with the carried-forward point data to the use condition storage server 8 such that they are stored in the carried forward point database.

The contents server 9 stores the contents data for every condition and provides the contents data to the entertainment terminal 6. The condition indicates the situation of congestion in the restaurant 11, the position of the table 13 in which the entertainment terminal 6 is arranged or the time zone when the contents data is viewed.

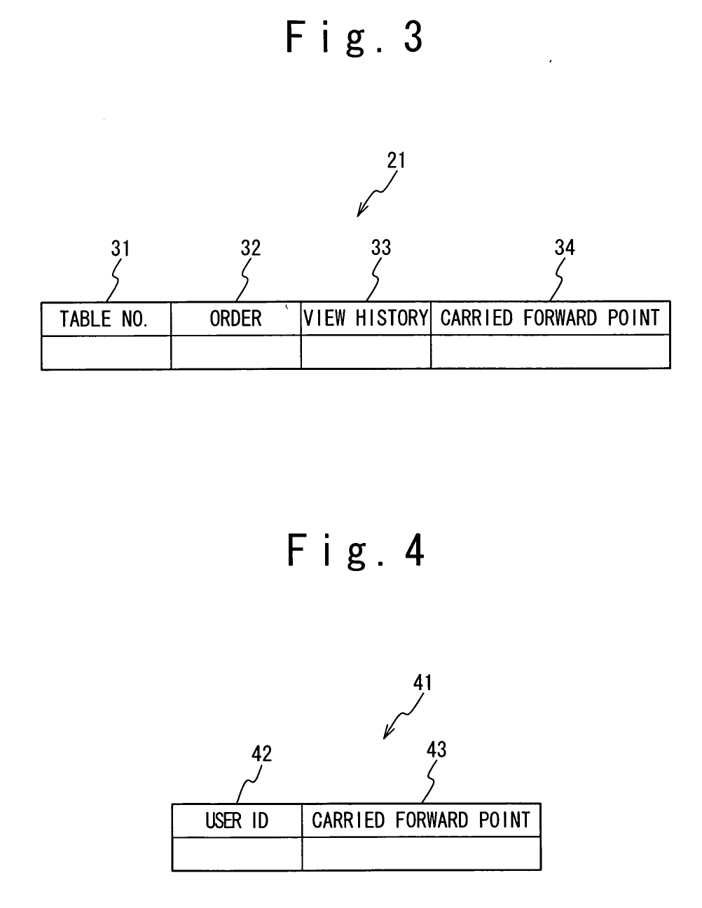

FIG. 3 shows the order database 21. The order database 21 stores the carried forward point data corresponding to the contents data possible to be displayed on the entertainment terminal 6 in correspondence to the table number 31. The table number 31 is data to identify the table 13. The order data 32, view history data 33 and the carried-forward point data 34 are stored in relation to the table number 31. The order data 32 is data received by the order receiving section 22 to indicate an item of menu which customer 15 ordered. The view history data 33 is data acquired by the history acquiring section 23 to indicate the point data corresponding to the contents data to have been displayed in past on the entertainment terminal 6. The carried-forward point data 34 is data acquired by the carried-forward point data acquiring section 24 to indicate the carried-forward point data. The carried forward point data may indicate the number of times or time to be able to view the contents data.

FIG. 4 shows the carried-forward point database 41 included in the use condition storage server 8. The carried-forward point database 41 stores the carried-forward point data 43 corresponding to the user identifier 42. The user identifier 42 is the data which is generated to identify the carried-forward point data transmitted by the carried-forward point data storing section 27 or is the data transmitted by the carried-forward point data storing section 27 in correspondence to the carried-forward point data. Identification data for identifying or specifying the mobile terminal 14, such as a manufacturing number, a telephone number, and an E-mail address may be used as the user identifier 42.

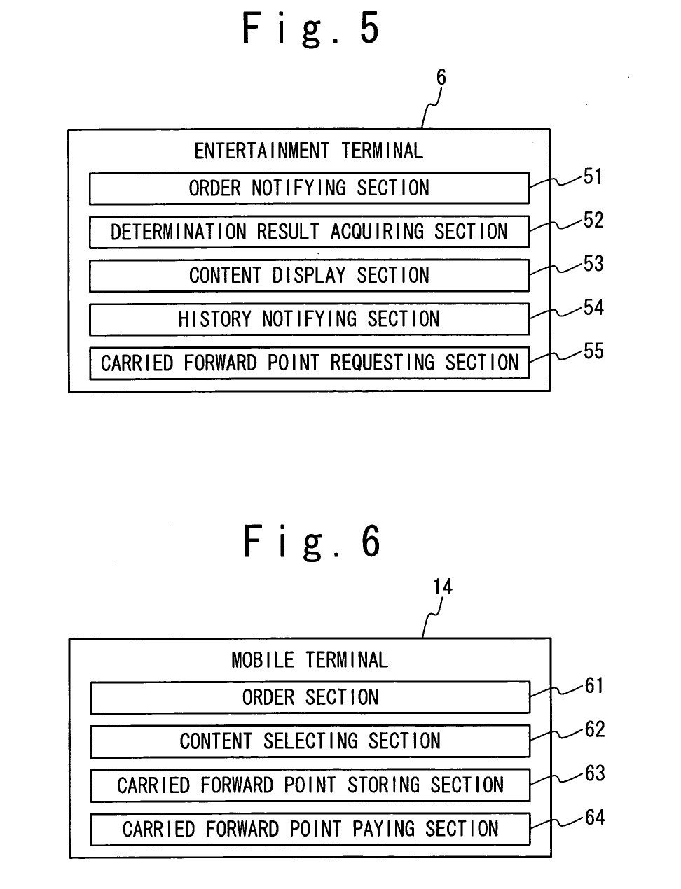

FIG. 5 shows the entertainment terminal 6 in detail. The entertainment terminal 6 is composed of an order notifying section 51, a determination result acquiring section 52, a content display section 53, a history notifying section 54 and a carried-forward point data requesting section 55, which are achieved by computer program.

The order notifying section 51 transmits an order from the customer 15 corresponding to the table number to the entertainment service apparatus 1 through the LAN 3 in response to input of the order to the entertainment terminal 6 in the restaurant 11. The entertainment terminal 6 receives the order by the operation of the customer 15 or through the infrared rays from the mobile terminal 14.

The determination result acquiring section 52 acquires and displays a list of the contents data possible to be displayed on the entertainment terminal 6 from the contents server 9. When the customer 15 selects one of the list of contents data through an operation of the entertainment service apparatus 6 by the customer 15, the determination result acquiring section 52 transmits an identifier of the contents data to the entertainment service apparatus 1 through the LAN 3, and acquires the determination result indicating whether the entertainment terminal 6 has the usable point data corresponding to the selected contents data, from the entertainment service apparatus 1.

The content display section 53 downloads the selected contents data from the contents server 9 when the determination result indicates that the entertainment terminal 6 has the usable point data sufficiently. The content display section 53 reproduces a sound (music) when the contents data indicate the sound. Also, the content display section 53 displays an indication that the contents data can not be viewed, when the determination result indicates that the entertainment terminal 6 does not have the usable point data sufficiently.

The history notifying section 54 transmits the used point data corresponding to the contents data to have been displayed on the display section 53 to the entertainment service apparatus 1. The carried-forward point data requesting section 55 transmits the user identifier inputted to the entertainment terminal 6 by the customer 15 to the entertainment service apparatus 1. The customer 15 may directly input the user identifier from an input device of the entertainment terminal 6 or input the user identifier by the infrared rays by operating the mobile terminal 14 to indicate the user identifier.

Also, the entertainment terminal 6 may be further composed of a contents database. The contents database stores the contents data to be viewed or used by the entertainment terminal 6. At this time, the determination result acquiring section 52 refers to the contents database and displays the list of the contents data possible to be displayed, and the content display section 53 refers to the contents database for the contents data to be viewed or used. Therefore, it is not necessary for the entertainment service apparatus 1 to contain the contents server 9. The contents data may be varied for every table 13 for which the entertainment terminals 6 is provided. For example, the contents database can be varied to the suitable and special contents data when the table 13 is such as a smoking table, a non-smoking table, a table near the window, and a table near a rest room.

Moreover, the entertainment terminal 6 may be composed of a computer program used to output the infrared rays to indicate the carried-forward point data. That is to say, the entertainment terminal 6 acquires the carried-forward point data corresponding to the table number from the order database 21 of the entertainment service apparatus 1 in response to the infrared rays outputted from the mobile terminal 14. The infrared rays may be outputted to indicate the carried-forward point data and deleted the part from the order database 21 by the entertainment terminal 6.

FIG. 6 shows the mobile terminal 14 in detail. The mobile terminal 14 is composed of an order section 61, a content selecting section 62, a carried-forward point data storing section 63 and a carried-forward point data outputting section 64, which are achieved by computer programs. The order section 61 outputs an infrared ray to indicate the order inputted to the mobile terminal 14 by the customer 15. The content selecting section 62 outputs the infrared ray to indicate the identification of the contents data inputted to the mobile terminal 14 by the customer 15. The carried-forward point data storing section 63 outputs the infrared ray to indicate a request for the carried-forward point data in response to the operation of the customer 15, and stores the carried-forward point data indicated by the infrared ray outputted from the entertainment terminal 6 or the cash register 7.

The carried forward point data outputting section 64 outputs the infrared ray to indicate the carried-forward point data stored in the carried-forward point data storing section 63 in response to the operation of the customer 15. The carried-forward point data storing section 63 deletes the carried-forward point data when the infrared rays indicating the carried-forward point data is outputted by the carried-forward point data outputting section 64.

The operation of the entertainment service system 2 is composed of an operation to receive an order, an operation to allow the entertainment terminal 6 to display the contents data, an operation to settle the expense and an operation to store the carried-forward point data by using the entertainment terminal 6.

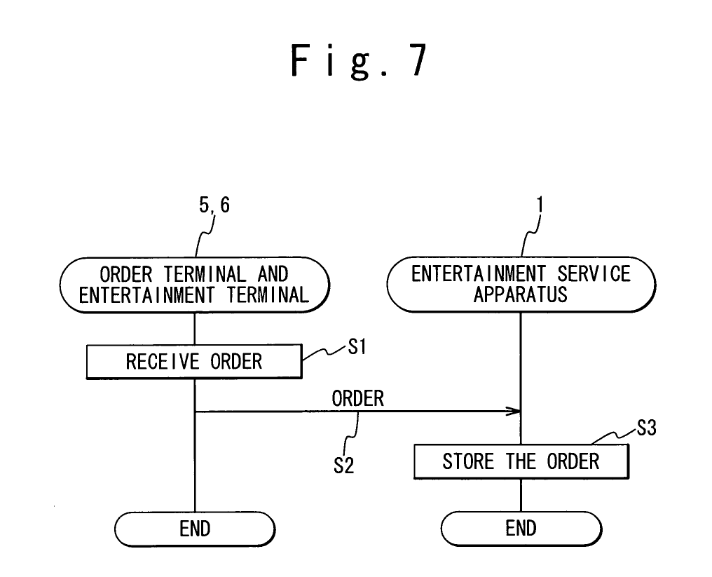

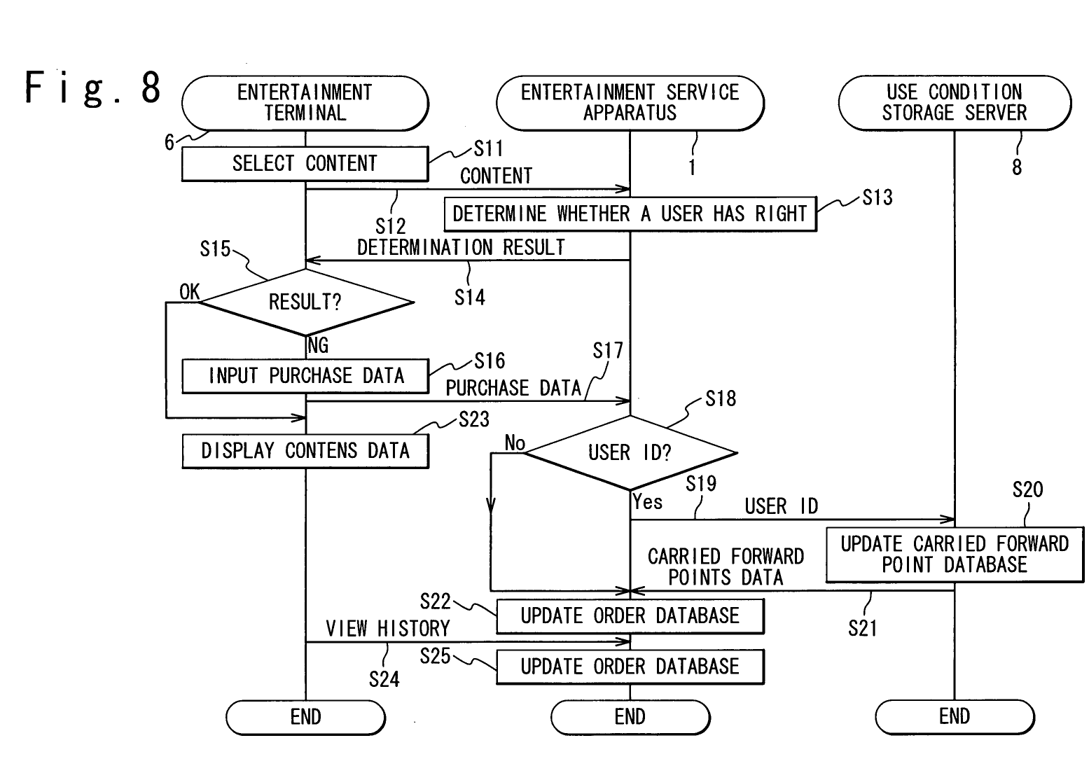

FIG. 7 shows the operation of receiving an order. When the customer 15 wants to take a meal at restaurant 11, the customer 15 first goes to the restaurant 11 and sits at the table 13 in accordance with the waiter 12. The waiter 12 hands the menu to the customer 15, asks an order to the customer 15 and inputs the order to the order terminal 5 together with the table number (Step S1). At this time, the waiter 12 holds the order terminal 5 over the barcode of the table 13 or the IC tag so that the table number can be read. Then, the order terminal 5 transmits the order data to the entertainment service apparatus 1 (Step S2). The order acquiring section 22 of the entertainment service apparatus 1 stores the order data in the order database 21 in correspondence to the table number (Step S3).

In this operation, the entertainment terminal 6 may be used in place of the order terminal 5. That is, when the customer 15 wants to take a meal at the restaurant 11, the customer 15 first goes to the restaurant 11 and sits at table 13 in accordance with the waiter 12. The customer 15 operates the entertainment terminal 6 to input an order (Step S1). Otherwise, the customer 15 operates the mobile terminal 14 and the order section 61 transmits the order to the entertainment terminal 6. The entertainment terminal 6 transmits the order data together with the table number to the entertainment service apparatus 1 (Step S2). The order acquiring section 22 of the entertainment service apparatus 1 stores the order data in the order database 21 in correspondence to the table number (Step S3). In this case, the waiter 12 is unnecessary to receive the order so that it is possible to reduce personnel expenses.

FIG. 8 shows a process of permission of display of the contents data on the entertainment terminal 6. First of all, the entertainment terminal 6 acquires the list of contents data possible to be displayed from the contents server 9 in response to a request from the customer 13, and display the list. For example, the list depends on whether the restaurant is crowd, the time zone, and the position of table 13. When the customer 15 operates the entertainment terminal 6 to select desired contents data from the list (step S11), the entertainment terminal 6 transmits an identifier of the desired contents data together with the table number to the entertainment service apparatus 1 (Step S12). The identifier of the desired contents data may be transmitted from the content selecting section 62 of the mobile terminal 14 to the entertainment service apparatus 1 through the entertainment terminal 6.

The point determination section 25 of the entertainment service apparatus 1 receives the contents data identifier and refers to the order database 11 to determine whether or not the customer of the entertainment terminal 6 has the right to display the desired contents data (Step S13). The point determination section 25 of the entertainment service apparatus 1 calculates a summation of point data calculated based on the order and the carried-forward point data for the user and determines whether the customer 15 has the right based on the calculated summation. When the summation is larger than the point data corresponding to the desired contents data to be displayed on the entertainment terminal 6, the point determination section 25 of the entertainment service apparatus 1 determines that the customer 15 has the right. On the contrary, the point determination section 25 of the entertainment service apparatus 1 determines that the customer 15 does not have the right when the summation is smaller than the point data corresponding to the desired contents data to be displayed. Then, the entertainment service apparatus 1 transmits the determination result to the entertainment terminal 6 (Step S14). The determination result acquiring section 52 of the entertainment terminal 6 acquires the determination result.

When the determination result indicates that the customer 15 does no have the right (step S15; NG), the customer 15 inputs a request to purchase the right to the entertainment terminal 6 or inputs the user identifier which has been acquired previously at the restaurant 11 to the entertainment terminal 6 (Step S16). It should be noted that the customer 15 may input the data to the mobile terminal 14, and the order section 61 of the mobile terminal transmits the data to the entertainment terminal 6 through the infrared rays. The entertainment service apparatus 6 transmits the purchase request of the right or the user identifier to the entertainment service apparatus 1 (Step S17).

The carried forward point data acquiring section 55 of the entertainment service apparatus 1 transmits the user identifier to the use condition storage server 8 (Step S19), when receiving the user identifier from the entertainment terminal 6 (step S18; YES). The use condition storage server 8 extracts the carried-forward point data corresponding to the user identifier, by referring to the carried forward point database 41 and transmits the carried forward point data to the entertainment service apparatus 1 (Step S21). Then, the carried forward point data corresponding to the user identifier is deleted from the carried-forward point database 41 (Step S20). The point determination section 25 of the entertainment service apparatus 1 calculates the summation of the point data based on the order and the received carried forward point data and the carried forward point data storing section 27 stores the calculated point data in the order database in correspondence to the table number of the table 13 where the customer is sitting (Step S22). When the order acquiring section 22 of the entertainment service apparatus 1 receives the purchase request of the right from the entertainment terminal 6 (step S18; NO), the order acquiring section 22 of the entertainment service apparatus 1 stores the purchase request as the order data in the order database, and the point determination section 25 calculates the summation of the point data based on the order and the already stored carried forward point data, and the carried forward point data storing section 27 stores the summation as the carried forward point data in the order database 31 (Step S22). Thereafter, the point determination section 25 of the entertainment service apparatus 1 determines whether the customer of the table 13 has the right to display the desired contents data on the entertainment terminal 6. The determination result acquiring section 52 of the entertainment terminal 6 acquires the determination result, in the same way as described above.

When the right is ordered or the summation of the point data corresponding to the user identifier exceeds the point data corresponding to the desired contents data so that the entertainment terminal 6 is determined to have the right (step S15; OK), the entertainment terminal 6 is permitted to acquire the content data from the contents server 9. The content display section 53 of the entertainment terminal 6 acquires the desired content data from the contents server 9 and displays the desired contents data (Step S23). The history notifying section 54 notifies the history of displaying the contents data to the entertainment service apparatus 1 (step S24). Then, the history acquiring section 23 of the entertainment service apparatus 1 acquires the history and stores it as the view history in the order database 21 (Step S25).

In case that the entertainment terminal 6 is determined not to have the right (step S15; NG), when the right is not purchased or when the carried-forward point data corresponding to the user identifier does not exists, the entertainment terminal 6 ends this operation without displaying the contents data.

According to the above-mentioned process, the customer 15 can not view or use the contents data using the entertainment without restraint. Furthermore, in order to view or use the contents data more, the customer needs to order meals more, to order the purchase request to view the contents data, or to use the carried-forward point data.

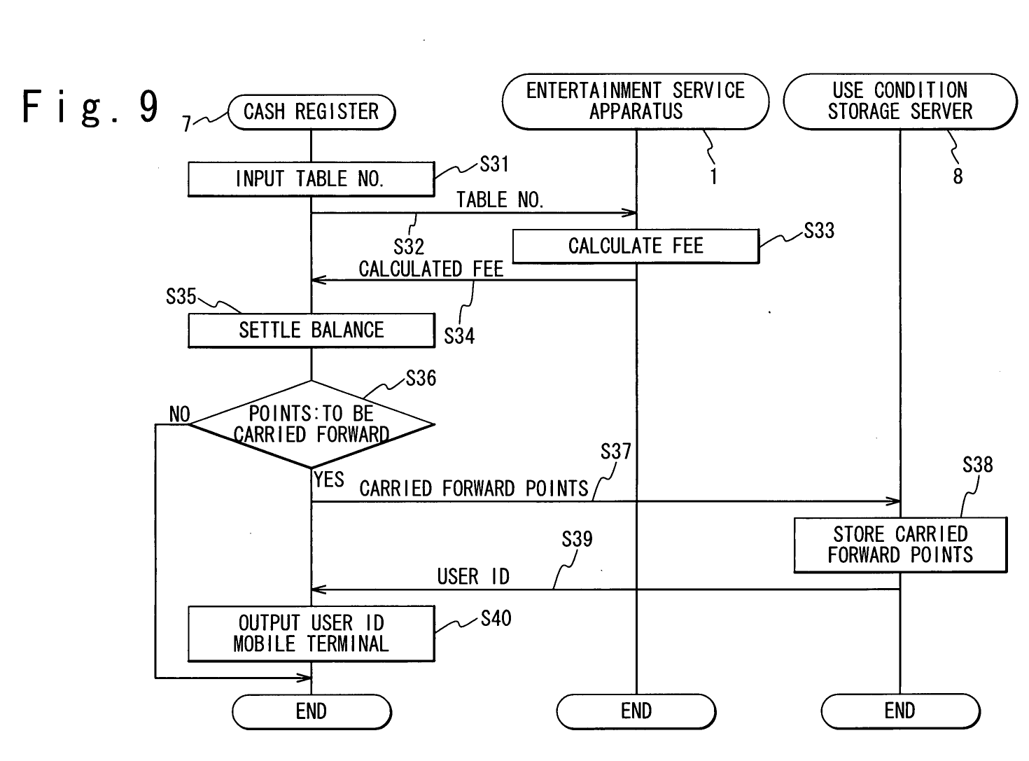

FIG. 9 shows the operation to settle the expense. The customer 15 finishes the meal or view of the contents data and goes to the cash register 7 first. A casher inputs the table number of the table 13 in which the customer sat to the cash register 7 (Step S31). The cash register 7 transmits the table number to the entertainment service apparatus 1 (Step S32). The settlement section 26 of the entertainment service apparatus 1 refers to the order database 21 based on the table number, and calculates the expense based on the order corresponding to the table number, the point data of the displayed contents data and the carried-forward point data (Step S33). That is, the expense is a summation of the expense for the ordered meal and the expense for the right to display the contents data on the entertainment terminal 6. The settlement section 26 of the entertainment service apparatus 1 notifies the expense to the cash register 7 (Step S34). Then, the casher settles the expense by using the cash register 7 (Step S35).

In case that the entertainment terminal 6 has a remainder point data corresponding to the right to display the contents data or there is a remainder point data in the entertainment service apparatus 1, if the customer 15 desires and asks to use the remainder point data as carried-forward point data in next time (Step S36; YES), the cash register 7 transmits the carried-forward point data together with the user identifier to the use condition storage server 8 through the entertainment service apparatus 1 (Step S37). The use condition storage server 8 stores the carried-forward point data in correspondence to the user identifier in the carried-forward point database 41 (Step S38). When the user identifier is not transmitted, the use condition storage server 8 allocates a new user identifier and transmits the user identifier to the cash register 7 (Step S39). Then, the cash register 7 transmits the user identifier to the mobile terminal 14 (Step S40). The carried forward point storing section 63 of the mobile terminal stores the user identifier. The casher hands a member's card in which the user identifier is wrote to the customer 15 when the customer 15 does not have the mobile terminal 15.

It should be noted that when data to identify the mobile terminal 14 is used as the user identifier, the above-mentioned Steps S37 to S40 are not executed. In this case, when the customer 15 asks to use the carried-forward point data next time, the cash register 7 acquires the user identifier through the infrared rays from the mobile terminal 14. The cash register 7 transmits the user identifier to the use condition storage server 8 together with the carried-forward point data. The use condition storage server 8 adds the received carried-forward point data to the carried-forward point data corresponding to the user identifier and stores the carried-forward point data in the carried-forward point database 41. The use condition storage server 8 newly stores the carried-forward point data corresponding to the user identifier when the user identifier has not been recorded.

In the operation to store the carried-forward point data by using the entertainment terminal 6, first, the customer 15 directly operates an input device of the entertainment terminal 6 in order to request the storage of the carried-forward point data. Otherwise, the customer 15 outputs the infrared rays to the entertainment terminal 6 in order to request the storage of the carried-forward point data by using the mobile terminal 14. The infrared rays further shows the user identifier which is already given to the customer 15. The entertainment terminal 6 transmits the user identifier to the entertainment service apparatus 1 in response to the input of the user identifier in order to request to store the point data for displaying the contents data for the entertainment terminal 6. The entertainment service apparatus 1 transmits the carried-forward point data to the use condition storage server 8 together with the user identifier corresponding to the request. The use condition storage server 8 adds the received carried-forward point data to the carried-forward point data corresponding to the user identifier in order to store the summation to the carried-forward point database 41.

By acquiring the user identifier, the customer 15 can view or use the contents data using the user identifier when he comes to the restaurant 11 next time. Thus, it could be promised that the customer will come to the restaurant 11 again. Because the use condition storage server 8 is set outside the restaurant 11, it is possible to use the user identifier at another restaurant when the use condition storage server 8 is used by other restaurant.

It should be noted that the entertainment terminal 6 may acquire the result of determination of whether the entertainment terminal 6 has the right to display the contents data, from the order terminal 5. At this time, the order terminal 5 outputs the determination result to the entertainment terminal 6 through the infrared rays to indicate the right to display the contents data, when the order from the customer 15 is inputted. Then, the entertainment terminal 6 displays a notice indicating that the right to display the contents data is acquired in response to the infrared rays. Moreover, the entertainment terminal 6 can display the contents data only a quantity indicated in the determination result. As a result, it is easy for the customer 12 to find that the contents data can be viewed through his order.

Also, the entertainment service system 2 may be also constituted without the use condition storage server 8. In this case, the carried-forward point data acquiring section 24 of the entertainment service apparatus 1 acquires the carried-forward point data acquired from the mobile terminal 14 through the entertainment terminal 6 and the carried forward point data storing section 27 stores the carried-forward point data into the order database 21. The carried-forward point data storing section 27 transmits the carried-forward point data to the mobile terminal 14 through the entertainment terminal 6 in response to the request outputted from the mobile terminal 14 through the entertainment terminal 6, when the entertainment terminal 6 has the right to display the contents data more. The carried forward point storing section 63 of the mobile terminal 14 receives and stores the carried-forward point data. At this time, the operation of the entertainment service system 2 differs from the above-mentioned embodiment in the operation to allow the entertainment terminal 6 to display the contents data and the operation to settle the expense. In this way, the operation to store the carried-forward point data from the entertainment terminal 6 to the mobile terminal 14 is added.

Next, the entertainment service system according to another embodiment of the present invention will be described. In the operation to allow the entertainment terminal 6 to display the contents data, the entertainment terminal 6 first acquires the list of contents data possible to be displayed from the contents server 9 and displays the list. When the customer 15 operates the entertainment terminal 6 to select the contents data from the list, the entertainment terminal 6 transmits an identifier of the contents data to the entertainment service apparatus 1. When receiving the contents data identifier, the entertainment service apparatus 1 refers to the order database 11 to determine whether or not the entertainment terminal 6 has the right to display the contents data. That is, the entertainment service apparatus 1 determines that the entertainment terminal 6 has the right when a summation of point data calculated on the basis of the order and a carried-forward point data is larger than point data corresponding to the contents data displayed by the entertainment terminal 6. On the contrary, the entertainment service apparatus 1 determines that the entertainment terminal 6 does not have the right when the summation is smaller than the point data corresponding to the contents data. The entertainment service apparatus 1 transmits the determination result to the entertainment terminal 6.

The customer 15 inputs a request to purchase the right to the entertainment terminal 6 when being determined not to have the right, or inputs the stored carried-forward point data through the infrared rays to the entertainment terminal 6 by operating the mobile terminal 14. The entertainment terminal 6 transmits the request of the right or the carried-forward point data to the entertainment service apparatus 1.

When receiving the purchase request of the right from the entertainment terminal 6, the entertainment service apparatus 1 stores the purchase request of the right into the order database 21. Also, when receiving the carried-forward point data from the entertainment terminal 6, the entertainment service apparatus 1 stores the carried-forward point data into the order database 21.

When the entertainment terminal 6 is determined to have the right, when the purchase request of the right is issued, or the carried-forward point data is inputted from the mobile terminal 14, the entertainment terminal 6 displays the contents data. The history of displaying the contents data is notified to the entertainment service apparatus 1. Then, the entertainment service apparatus 1 stores the history in the order database 21. When the entertainment terminal 6 is determined not to have the right, when the purchase request of the right is not issued or the carried-forward point data is not inputted from the mobile terminal 14, the entertainment terminal 6 ends this operation without displaying the contents data.

In an operation to settle the expense in another embodiment of the present invention, the customer 15 finishes the meal and the view or use of the contents data and goes to the cash register 7 first. A casher inputs a table number of the table 13 in which the customer sat, to the cash register 7. The cash register 7 transmits the table number to the entertainment service apparatus 1. The entertainment service apparatus 1 refers to the order database 21, and calculates an expense based on the order corresponding to the table number, the point data of the displayed contents data and the carried-forward point data, and notifies the expense to the cash register 7. The casher settles the expense using the cash register 7.

When the entertainment terminal 6 has an extra point data corresponding to the right to display the contents data and the customer 15 desires and asks to use the extra right as a carried-forward point data in next time, the carried-forward point data is acquired by the entertainment service apparatus 1, and outputted by the infrared ray to indicate the carried-forward point data. The mobile terminal 14 receives the infrared ray and stores the carried-forward point data.

In the operation storing the carried-forward point data from the entertainment terminal 6 to the mobile terminal 14, first, the customer 15 outputs the infrared ray to the entertainment terminal 6 by using the mobile terminal 14 to request the storage of the carried-forward point data. The entertainment terminal 6 transmits the table number to the entertainment service apparatus 1 in response to the request. The entertainment service apparatus 1 replies the carried-forward point data corresponding to the right to display the contents data and corresponding to the table number to the entertainment terminal 6. Then, the entertainment terminal 6 outputs the infrared ray to the mobile terminal 14 to indicate the carried-forward point data. The mobile terminal 14 receives the infrared rays and stores the carried-forward point data.

By acquiring the user identifier, the customer 15 can view the contents data using the user identifier when he comes to the restaurant 11 next time. Further, the customer 15 can use the carried-forward point data at the different restaurants from the restaurant 11.

As described above, according to the entertainment service apparatus and the entertainment terminal of the present invention, it is possible to prevent the customer from viewing contents data without limitation.

What is claimed is:

1. A method of providing contents data in an entertainment service system, comprising:
generating a request of desired contents data from an entertainment terminal;
determining whether a customer has a right to display contents data, in response to said desired contents data request;
retrieving said desired contents data from a contents database based on said determination result, when said customer has the right; and
displaying said desired contents data on said entertainment terminal.

2. The method according to claim 1, wherein said generating comprises:
generating said desired contents data request from said entertainment terminal together with identifier for identifying said entertainment terminal.

3. The method according to claim 1, wherein said determining step comprises:
calculating a summation of order point data determined based on an order and carried-forward point data;
comparing said summation and point data necessary for said desired contents data;
determining that said customer has the right when said summation is equal to or larger than said necessary point data; and
determining that said customer does not have the right when said summation is equal to or larger than said necessary point data.

4. The method according to claim 3, further comprising:
generating said order directly from said entertainment terminal or through a mobile terminal of said customer.

5. The method according to claim 3, further comprising:
settling an expense for said order;
subtracting said necessary point data from said summation; and
storing a remainder as the result of said subtraction as said carried-forward point data.

6. An entertainment service apparatus comprising:
an order receiving section which receives orders from an order terminal for every identification for identifying an entertainment terminal; and
a determining section which determines whether a customer has a right to display desired contents data on said entertainment terminal, based on said orders, and notifies the determination result to said entertainment terminal,
wherein said entertainment terminal is available to display said desired contents data when said determination result indicates that said customer has said right.

7. The entertainment service apparatus according to claim 6, wherein said orders contain an order of displaying said desired contents data on said entertainment terminal.

8. The entertainment service apparatus according to claim 7, further comprising:
a settling section which calculates an expense based on said orders and notifies said expense to a cash register.

9. The entertainment service apparatus according to claim 8, further comprising:
a history acquiring section which acquires used point data corresponding to said desired contents data having displayed on said entertainment terminal; and
a storing section which stores as carried forward point data in a carried-forward point database, point data obtained by subtracting said used point data from a summation of said purchased point data, point data given for said order other than said order of displaying said desired contents data and carried-forward point data, at the calculation of said expense,
wherein said determination result indicates that said customer does not have said right when purchased point data calculated based on said order exceeds said used point data.

10. The entertainment service apparatus according to claim 9, further comprising:
a carried-forward point data acquiring section which acquires said carried forward point data corresponding to said user identifier from said carried-forward point database, when said customer requests the display of said desired contents data,
wherein said determination result indicates that said customer has the right when said used point data is smaller than said summation.

11. The entertainment service apparatus according to claim 10, wherein said carried-forward point database is arranged in a use condition storage server,
said storing section transmits said carried-forward point data and a user identifier of said customer in said use condition storage server, such that said carried-forward point data is stored in said carried-forward point database in relation to said user identifier,
said carried-forward point data acquiring section reads out said carried-forward point data from said use condition storage server based on said user identifier acquired on the reception of said order of displaying said desired contents data.

12. The entertainment service apparatus according to claim 10, wherein said entertainment terminal acquires said user identifier from a mobile terminal, and
said user identifier is data for identifying said mobile terminal.

13. The entertainment service apparatus according to claim 12, further comprising:
said storing section stores said carried forward point data in said mobile terminal through said entertainment terminal, and
said carried-forward point data acquiring section acquires said carried-forward point data from said mobile terminal through said entertainment terminal.

14. The entertainment service apparatus according to claim 6, wherein a tag is provided near said entertainment terminal, and
said order terminal includes a reader which reads said number from said tag.

15. The entertainment service apparatus according to claim 14, wherein a barcode is written on said tag, and
said reader reads said number from said barcode.

16. The entertainment service apparatus according to claim 14, wherein said tag is an IC tag which outputs a response radio wave to show said number in response to irradiation of predetermined radio wave, and
said reader is an IC tag reader which outputs said predetermined radio wave to said IC tag and reads said table number from said response radio wave.

17. An entertainment terminal comprising:
an order notifying section which notifies orders to an entertainment service apparatus;
a determination result acquiring section which acquires from said entertainment service apparatus, a determination result of whether or not a customer has a right to display desired contents data based on said orders; and
a contents data display section which displays said desired contents data when said determination result indicates that said customer has the right.

18. The entertainment terminal according to claim 17, further comprising:
a history notifying section which notifies used point data corresponding to said desired contents data displayed on said entertainment terminal, to said entertainment service apparatus,
wherein said determination result indicates that said user does not have the right when said used point data exceeds calculation point data calculated based on said orders.

19. The entertainment terminal according to claim 18, further comprising:
a carried-forward point data requesting section which notifies a user identifier inputted through an operation of said entertainment terminal by said customer to said entertainment service apparatus,
wherein said entertainment service apparatus retrieves carried-forward point data corresponding to said user identifier from a carried-forward point database, and
said determination result indicates that said user has the right when said used point data is smaller than a summation of said calculation point data and said carried-forward point data.

20. The entertainment terminal according to claim 19, wherein said carried-forward point data requesting section acquires said user identifier from a mobile terminal.

21. The entertainment terminal according to claim 20, wherein said user identifier is data for identifying said mobile terminal.

22. The entertainment terminal according to claim 17, further comprising:
a contents database which stores contents data,
wherein said contents data display section refers to said contents database to display said desired contents data.

23. A software product executable by a computer and achieving the functions of:
receiving orders from an order terminal for every identification for identifying an entertainment terminal;
determining whether a customer has a right to display desired contents data on said entertainment terminal, based on said order; and
notifying the determination result to said entertainment terminal.

24. A software product executable by a computer and achieving the functions of:
notifying orders to an entertainment service apparatus;
acquiring from said entertainment service apparatus, a determination result of whether or not a customer has a right to display desired contents data based on said orders; and
displaying said desired contents data when said determination result indicates that said customer has the right.
